(19) United States
(12) Patent Application Publication
(10) Pub. No.: US 2010/0009262 A1
(43) Pub. Date: Jan. 14, 2010

(54) Non-lead grid cores for lead acid battery and method of their production

(76) Inventor: Eliot Gerber, Moraga, CA (US)

Correspondence Address: ELIOT GERBER, 127 DEVIN DR, MORAGA, CA, 94556, US

(21) Appl. No.: 12/218,154

(22) Filed: Jul. 11, 2008

(51) Int. Cl. H01M 4/68; C25D 11/00

(52) U.S. Cl. 429/245; 205/317

(57) ABSTRACT

In a lead acid electric storage battery using conventional lead-acid secondary battery chemistry, the battery may be a sealed battery, an unsealed battery, a conventional multi-cell battery, or a bi-polar battery. The battery has a set of composite negative battery grids (plates) which are constructed with a thin aluminum core having a thickness preferably in the range 0.05 mm to 1.3 mm and most preferably 0.2 mm to 0.6 mm. A layer of aluminum oxide removal metal, preferably zinc or tin, covers the aluminum core. Optionally, a protective film of tin dioxide, preferably less than 0.1 mm thick, and most preferably 1-20 microns, completely covers the removal layer. The tin dioxide layer, or the removal layer, is covered with a thin protective coating film of conductive fluoropolymer plastic. Preferably the grid cores are of expanded aluminum metal. These aluminum core grids are preferably used as negative grids and are preferably used with thin expanded metal positive titanium or stainless steel grids to form a high energy density battery.

### FIELD OF THE INVENTION

The present invention relates to lead acid storage batteries, and more especially to the grids for such batteries and to the methods of their production.

### BACKGROUND OF THE INVENTION

The need for improvements in lead-acid storage batteries is widely recognized. Hundreds of articles, patents and research projects have been directed toward improving such batteries. Some of the important characteristics that still need improvement are the cost of the grids (plates), pollution problems associated with the use of lead grids, battery power compared to size and weight, cold starting, mechanical ruggedness, quick charging, long life and multiple cycles (charge-discharge).

One example of a use in which a better battery may be important is in “plug-in hybrid” vehicles. A hybrid car such as a Prius (Toyota) may obtain up to 55 miles per gallon using the combination of a gas and electric motors. In a plug-in hybrid (PHEV—plug hybrid electric vehicles), a large battery is added to hybrid car so that for the first 20 to 60 miles of driving each day the car becomes, in effect, a purely electric car. To be widely accepted, the battery pack for the PHEV should cost less than $2000, about one fifth the cost of a Li-Ion battery pack.

If a plug-in hybrid, using the batteries of the present invention, could drive 40 miles daily only on its battery, on average its gas engine would not be used in daily driving. Such a typical car would not use any gasoline.

The plug-in hybrid may be recharged at low cost which may be reflected in electric billing. There is a great interest in such plug-in hybrid cars as they reduce air pollution, especially carbon dioxide, and reduce the need for petroleum imports, see Cal Cars.org and hybrid cars.com.

Professor Andrew Frank of the University of California Davis and his hybrid center have built about 16 plug-in hybrid cars and studied about 40 battery types in a Prius and hybrid SUV. The best batteries were lithium ion types which by themselves could propel the Prius about 60 miles. However a pack of the best batteries for each car would cost over $10,000. In contrast, the conventional lead acid batteries for the same car would cost under $2000. That price is much less than the lithium ion type of batteries. However conventional lead acid batteries propelled the Prius only 20 miles.

It has been suggested that the power of lead acid batteries may be increased by substituting lead grids with other materials. However, it is believed that all commercially available lead acid batteries use solid lead grids. There are now a number of research projects that have been reported to use non-metal battery plates. Firefly Energy has announced it is developing carbon foam plates, see U.S. Pat. Nos. 979,513 and 7,033,703. Also, Jung et al have filed patent applications on carbon battery plates, see U.S. application Ser. Nos. 11/048,104 and 11/279,103.

One suggestion found in the literature is to use lead plate on a core of another metal, such as aluminum, copper, steel or titanium. Some of the prior patents and articles about lead-plated cores, or otherwise relevant, are set forth below. All of these patents and articles, and others mentioned in this patent application, are included herein by reference.

U.S. Pat. No. 4,683,648 to Yeh shows a titanium plate covered with lead. U.S. Pat. Nos. 5,379,502, 5,339,873, 5,544,681, and 5,411,821 disclose copper or steel or other materials as cores with titanium and lead layers. U.S. Pat. Nos. 6,316,148 to Bhardwaj discloses a battery using aluminum foil which is coated with lead. U.S. Pat. Nos. 2,739,997 and 2,713,079 to Carrick disclose aluminum plates electroplated with lead in an aqeuous plating bath. U.S. Patent Re: 33133 to Kiessling discloses a copper plate covered with lead. The following articles may be considered relevant: Dai et al. “Lead-plated titanium grids etc.” 41 Power Sources Conference, Jun. 14-17 (2004); Dai et al. “Corrosion of Lead Plate Titanium etc” (ref.on Google); Kurisawa “Development of Positive Electrodes with Tin Oxide Coating by Applying a Sputtering Technique for Lead Acid Batteries.” Journal Power Sources 1995 (2001) 1-5, 1-9.; Roos et al “Corrosion protection of aluminum surfaces using pyrolytic tin oxide” Appl. Phys. Lett 59(1) July 1991; and Yolshina et al. A lead-film electrode on an aluminum substrate etc.” Jour. of Power Sources 78, issues 1-2, March 1999, 84-87.

### SUMMARY OF THE INVENTION

In accordance with the present invention grids (plates) for lead acid storage batteries, either conventional sealed and unsealed lead acid batteries or bipolar lead acid batteries, consist of thin grids, not foil, of aluminum. By thin grids is meant that the grid (plate) is stiff enough to be self-supporting, e.g. it supports itself if stood on one edge, as distinct from foil which is thinner and is not self-supporting. The thickness of the aluminum and titanium grids are 0.05 mm to 2 mm, preferably 0.1 mm to 0.6 mm, most preferably 0.2 mm to 0.6 mm and in any event less than 2 mm. Preferably the grid is formed using expanded metal technology. The aluminum negative grid is cleaned and then treated in a double zincate, or a cadmium conversion process, to remove or convert its aluminum oxide layer. It may then, optionally, be coated in a heated chamber to form a micrometer-range thin protective coating of tin dioxide on the grid. The aluminum grids are used as especially as the negative grids and they are coated with a protective coating of conductive fluoropolymer layer, preferably in the 0.5-30 micron thick range but less than 50 microns. The titanium grids are especially positive grids and they are treated to form a micron thickness layer of titanium-nitride. Optionally, but not preferably, the grids may then be then electroplated with lead, preferably in a electroplating bath, to form a dense lead covering layer. Preferably the lead coating is 0.001 to 3 mm thick on each face and most preferably 10 microns to 300 microns thick on each face and in any event, less than 3 mm thick on each face. Preferably the finished grids are about 0.3-0.5 mm thick so that they may be processed by conventional automated battery paste filling machines. The grids may be flattened to be thin enough so that many grids i.e. 300 may be used in an auto battery size case.

### BRIEF DESCRIPTION OF THE DRAWINGS

In the drawings: FIG. 1 is a top plan view of a group of grids before they are separated, as they come out of the expander machine; and

FIG. 2 is a top plan view of grids as they are stamped and as they enter the processing tanks.

### DETAILED DESCRIPTION OF THE INVENTION

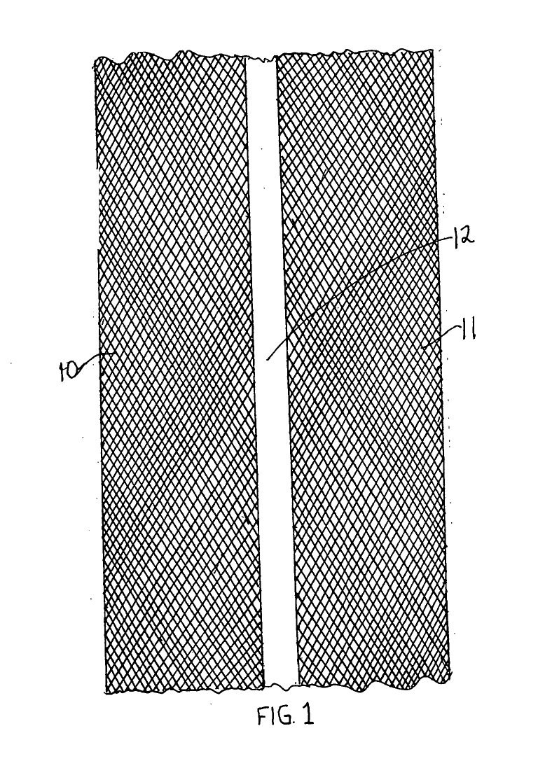

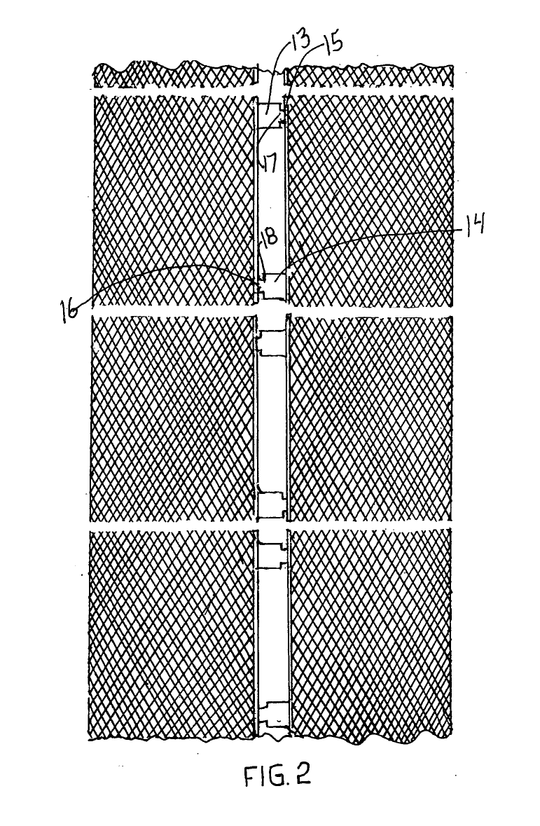

The grid 10 of FIGS. 1 and 2 is formed from an aluminum or titanium thin sheet (thin coil). Its thickness is in the preferred range of 0.05 mm to 3.00 mm and most preferably 0.1 mm to 0.6 mm and in any event, less than 0.8 mm. Preferably the thickness of the plate is about 0.25-0.45 mm.

The grids may be thin, for example, thin as the thickness of the end wall of an aluminum beverage can which has a thickness of about 0.2 to 0.4 mm. Aluminum has good electrical conductivity compared to lead; it is stronger than lead; it is much lighter than lead; however it is not corrosion resistant to the dilute sulfuric acid (“battery acid”) used in lead acid batteries.

The grade of the aluminum is not critical, however the aluminum preferably should be completely free of copper and copper impurities over 0.5%. Also the battery should be free, including lugs, of lead antimony as antimony possibly, has an adverse effect this type of battery. However, this has not been tested by us.

An aluminum core having a preferred thickness of 0.2 mm to 0.6 mm. is inexpensive. The aluminum core may, optionally, be treated to form a complete coating thereon of tin dioxide, using sol-gen technology. Tin dioxide, SnO₂, also known as stannic oxide, is an oxide of tin, with tin in oxidation state +4. The naturally occurring mineral is called cassiterite. The following is a report on a method of coating aluminum cores with tin dioxide. The thickness of the coating is in the preferred range of 0.5 microns to 10 microns and most preferably in the range 0.5 to 2.0 microns, for example 1 micron.

The cleaning procedure we have used is to soak the grids in the following liquids for 10 minutes in each liquid: 1. acetone or acetal acetate, 2. water and detergent with ultrasonic, 3. water with ultrasonic, 4. derionized water with ultrasonic, 5. distilled water with ultrasonic, 6. isopropal alcohol. The aluminum oxide on the surface of the grids is then removed by cadmium conversion, if the following coating is a paint. For example, a non-chrome conversion called Iridite NCP is available from MacDermid. However, if the following coating is electroless nickel the oxide is removed by a double zincate process, for example Metex zincate 6811 from Gallade Chemical.

One preferred method of obtaining a conductive fluoropolymer coating is to dip the grids, or spray the grids, twice with a fluoropolymer paint (10-30%) and nickel flakes (90-70%) for a 1 micron thick coating, the range being 0.5 to 5 microns. A suitable paint is SKU-20043 from Shield Products, FL. made under U.S. Pat. No. 5,106,894. A suitable nickel flake product is Inco-Novamet HCA-1, the flakes being about 1 micro thick and conductive.

The preferred alternative method is to deposit a Ni-PTFE (nickel-“Teflon” DuPont™) coating of 0.5-50 microns, preferably 25 microns, from an aqueous solution by electroless nickel (EN)plating techniques. Prepared Ni-PTFE solutions are available from Sirius Technology company (Millenium TCN-8 or TCN-10) or from Ethone-Cookson Electronics (Endplate 845 with 20-25% PTFE). Preferably the surface is then activated by an arc plasma or sodium etching solution to improve adhesion, for example, a low-power arc plasma using feed gases (O₂, Ar, N₂ and NH₃).

A fluoropolymer is a polymer that contains atoms of fluorine. It is characterized by a high resistance to solvents, acids, and bases. Examples of fluoropolymers are: PTFE (polytetrafluoroethylene), PFA (perfluoroalkoxy polymer resin), FEP (fluorinated ethylene-propylene), ETFE polyethylenetetrafluoroethylene; PVF polyvinylfluoride ECTFE polyethylenechlorotrifluoroethylene; PVDF polyvinylidene fluoride; PCTFE, CTFE polychlorotrifluoroethylene; FFKM; FFKM; FPM/FKM.

The fluoropolymer is made electrically conductive (same range as metal). It is known to fill a fluoropolymer with graphite or/and lamp black. Howe That product is not satisfactory for the grids as it is only semi-conductive, and not conductive. The conductivity of the fluoropolymer coating should be less then 10 ohms/square and preferably less than 1 ohm/square.

### EXAMPLE 1

### Auto Battery with Low Cost Negative Grids

A conventional auto battery has 60 lead grids, each weighing 60 grams. Based upon recent London Metals Exchange prices, lead is USD $0.80 lb. The cost would be $3.17. Aluminum is about 4 times lighter than lead. Aluminum grids cost should be: weight(measured) 9 grams×30=270 gms=0.59 lbs. at $1.30 lb=0.77(material cost of the core).

### EXAMPLE 2

### High Power/Energy Battery with 300 Plates

This battery has about the same size and weight as some present auto batteries (DIN 56311) but has 5 times their power/energy. That conventional auto battery has less energy/power because it has fewer grids. The grids of this Example 2 can be arranged into 30 cells of 10 grids per cell to give a voltage of 60 volts. The size should be the same as an auto battery, for example if the separators are 0.3 mm thick and the paste thin (0.2 mm) each group of grid, separator and paste would be 0.9 mm×300=270 mm (10.6 in). This type of power battery should be able to replace, for example the B&B Battery EVP20-12 used by Dr. Frank in a Prius PHEV. The B&B. Battery EVP20-12 he used has grids 6.6 cm×15.6 cm=103 sq.cm×48=4944 sq.cm.(estimate). The grids of this Example 2 are 14.0 cm×11.5 cm=161 sq.cm×300=48,300 sq.cm.(estimate). He used 22 batteries which added 209 lbs and provided 19.5 miles. Four batteries of the present invention should cost less than $2000, weight less than 220 pounds, occupy less than 1.3 cu.ft in volume and propel a Prius over 35 miles. This should make plug-in hybrid cars less expensive, over 2 years of usage, than gasoline or diesel cars, because generally they would not use any petroleum fuel.

### EXAMPLE 3

### Aluminum Core Grids for Negative Grids

3a. Aluminum expanded metal coated with 3 microns EN (electroless nickel)+3 microns EN with PTFE (Teflon)+50 microns lead.

3b. Aluminum expanded metal coated with 3 microns EN+3 microns EN with PTFE (Teflon)+1-2 microns tin.

3c. Aluminum expanded metal coated with PTFE 25% and nickel flakes 75% and the “activated” in sodium solution to make the surface so material can stick to it.

3d. Aluminum expanded metal coated with TTH coating from CSL-Plating. EN+PTFE (38 microns) thick and then activated in sodium solution. These grids are preferred for the negative grids of the battery of Example 2. The patents and articles cited above use different thicknesses of lead coated on the battery plates, as follows: in microns—Yeh (100); Carrick (370); Rowlette (25); Dai (15) and Yolshina (200).

The term used herein of an “aluminum oxide film removal metallic layer” means a layer of a metal material which removes the film of air or oxygen. This “removal layer” forms a micron range thin layer of a metallic material. A preferred layer of this type is formed by immersion of the cleaned aluminum grids is a zincate solution. A suitable zincate solution is: 3 quarts distilled water and 1 quart of zincate concentrate from Caswell (www.caswellplating.com). An alternative zincate solution is: sodium hydroxide 440 gms/liter; zinc oxide 87 gms/liter; and immersion time 10-30 seconds. An alternative to the zincate is a stannate

The term “tin dioxide”, as used herein and in the claims, includes the various names and forms of tin dioxide including tin oxide, stannous oxide, stannic oxide, and includes various dopants and includes other layers, such as a layer of tin over the tin dioxide and under the lead layer. The dopant or combination of dopants should be such as to be effective to improve the electric conductivity (reduce the resistivity) of the tin oxide coating on the substrate. The preferred dopant for tin dioxide coating is selected from the group consisting of fluoride ion, antimony ion and mixtures thereof. Fluoride ion is particularly preferred since it is especially tolerant of the aggressive environment in a lead-acid battery.

As shown in FIGS. 1-2 the core aluminum grids are formed in a metal expander machine. For the high power/energy battery the grids are flattened by being pressed between rollers to form flattened expanded metal. For example, as shown in FIG. 1, cores 12 cm. wide are formed from strips 10, 11 with a solid strip 12 of 2 cm. The lugs 13,14 are 1.5 cm high and are cut at their protrusions 15,16. The raw edge of the protrusions, after cutting and assembly in a battery, are within a lead bar and need not be treated. However, the small edge 17,18 should be corrosion protected, for example by being coated with non-conductive fluoropolymer paint.

For many applications the grids should be lead-free. The over-coat of lead may be omitted and a thin layer, preferable 1 to 5 microns thick, of tin or nickel may be plated over the conductive fluoropolymer layer. Alternatively, the fluoropolymer layer may be left uncoated so that it becomes the outer later of the composite grid.

The “high power battery” described above is a type of deep discharge battery, which tends to corrode the positive grids. A longer lasting power battery preferably uses the aluminum core grids for the negative grids and expanded metal grids of titanium for the positive grids. Preferably the titanium is nitrated to form a protective layer of TiN (titanium nitrate), preferably 1-5 microns thick, which is not covered with lead. By “expanded metal” is meant expanded metal, flattened expanded metal, metal woven net and punched metal. These grids are thin, in the range of 0.1 mm to 0.6 mm. thick. The battery is packed with the thin grids so that there are at least 8 grids (positive, negative, and separators) for each cm. of length. A conventional battery has only 2 to 3 grids per cm. of length.

Preferably the nitrated titanium grids, or expanded stainless steel grids, are further protected with a coating of conductive fluropolymer, as described above; for example EN-PTFE (TTH coating from CSL Plating, Santa Rosa, Calif.) at 38 microns thickness.

What is claimed is:

1. A lead-acid battery containing a plurality of electrode battery grids,
(a) at least some of the grids being an aluminum grid of expanded metal in a thickness of less than 0.6 mm and not a foil;
(b) said aluminum grid having a thin protective covering coating of an electrically conductive fluoropolymer, the protective coating having a thickness of less than 0.1 mm.

2. A lead-acid battery as in claim 1 wherein all the negative grids are of the type of claim 1.

3. A lead-acid battery as in claim 1 wherein:
(a) said aluminum grids protective covering coating of electrically conductive flouropolymer has a thickness of less than 100 microns; and
(b) a coating of lead of less than 0.1 mm covering said protective coating.

4. A lead-acid battery as in claim 3 wherein all the negative grids are of the type of claim 3.

5. A lead-acid battery as in claim 1 wherein:
(a) an aluminum oxide removal layer completely covers said aluminum grid; and
(b) said thin protective covering coating of electrically conductive fluoropolymer covers said removal layer; and
(c) the protective coating has a thickness of less than 100 microns.

6. A lead-acid battery as in claim 5 wherein all the negative grids are of the type of claim 1.

7. A lead-acid battery as in claim 1 wherein:
(a) said aluminum protective covering coating has a thickness of less than 100 microns and has an activated layer so that the grid adheres to battery paste; and
(b) said aluminum grid is lead-free.

8. A lead-acid battery as in claim 7 wherein all the negative grids are of the type of claim 7.

9. A lead-acid battery as in claim 1 wherein:
(a) said aluminum grid has an aluminum oxide removal layer completely covering said aluminum grid;
(b) a thin protective coating of tin dioxide covers said oxide removal layer; and
(d) said thin protective coating of electrically conductive fluoropolymer covers said tin dioxide coating.

10. A lead-acid battery as in claim 9 wherein all the negative grids are of the type of claim 9.

11. A lead-acid battery as in claim 1 wherein:
(a) an aluminum oxide removal layer completely covers said aluminum grid;
(b) said thin protective coating of electrically conductive fluoropolymer plastic covers said oxide removal layer; and
said lead-acid battery has a plurality of positive battery grids, each positive grid having a core of expanded metal in a thickness of less than 0.6 mm, each positive grid core not being a foil, said expanded metal positive grid core selected from the group of titanium and stainless steel.

12. A lead-acid high power battery having a length and containing a plurality of positive and negative electrode battery grids;
(a) at least some of the positive and negatives grids being grids of expanded metal in a thickness of less than 0.6 mm and not a foil;
(a) at least some of said expanded positive metal grids selected from the group of stainless steel and titanium;
(c) wherein the battery is packed with grids and separators with at least eight grids for each centimeter of length of the battery.

13. A method of making lead-acid battery having a plurality of composite battery grids, said grids having a flat aluminum core which is self-supporting and not a foil and having front and back faces; the method including the steps, in sequence, of:
(a) cleaning said aluminum core;
(b) removing aluminum oxide from said core with an aluminum oxide removal layer which remains on the aluminum core to completely cover said aluminum core; and
(c) covering said aluminum core with a thin (less then 50 microns) protective coating of electrically conductive fluoropolymer material.

14. The method as in claim 13 and covering said removal layer with a thin protective coating of tin dioxide, the tin dioxide coating having a thickness of less than 0.1 mm.

15. The method as in claim 13 and covering said fluoropolymer with lead in an electroplating bath to form a lead coating which is 10-50 microns thick on each face.
